(19) United States
(12) Patent Application Publication
(10) Pub. No.: US 2014/0125900 A1
(43) Pub. Date: May 8, 2014

(54) LCD ASSEMBLIES AND METHODS FOR MAKING THE SAME

(71) Applicant: Cheng-Chung Li, Painted Post, NY (US)

(72) Inventor: Cheng-Chung Li, Painted Post, NY (US)

(21) Appl. No.: 13/671,170

(22) Filed: Nov. 7, 2012

(51) Int. Cl. G02F 1/1333; H01J 9/24; G02F 1/1335; G02F 1/136; G02F 1/13357

(52) U.S. Cl. 349/42; 349/158; 349/61; 349/69; 349/96; 349/137; 445/24

(57) ABSTRACT

An LCD assembly may include an LCD cell, a front cover glass sheet, and a back cover glass sheet. The LCD cell may include a first surface and a second surface. The front cover glass sheet may include a first surface and a second surface. The second surface of the front cover glass sheet may be directly bonded to the first surface of the LCD cell. The front cover glass sheet may be strengthened glass. The back cover glass sheet may include a first surface and a second surface. The first surface of the back cover glass sheet may be directly bonded to the second surface of the LCD cell. The back cover glass sheet may be strengthened glass. The LCD assembly may be transparent to light projected onto the second surface of the back cover glass sheet to enable display of an image.

### BACKGROUND

1. Field

The present specification generally relates to liquid crystal display (LCD) assemblies for use in electronic devices for displaying images, and more specifically, to LCD assemblies with improved mechanical strength and methods for making the same.

2. Technical Background

LCD assemblies are employed in both consumer and commercial electronic devices such as televisions, computer monitors, and the like. LCD assemblies for electronic devices require enhanced strength to be able to withstand not only incidental contact and impacts which may occur when the device is being used, but also other contact and mechanical stress that may occur during the manufacture or transport of the LCD assemblies. Additionally, as the height and width of LCD size increase and the thickness decreases, the mechanical integrity of LCD assembly must be improved to ensure that the LCD cell will not be not damaged during routine activities.

Accordingly, a need exists for alternative LCD assemblies which are mechanically robust.

### SUMMARY

The embodiments described herein relate to LCD assemblies with improved mechanical strength. According to one embodiment, An LCD assembly may comprise an LCD cell, a front cover glass sheet, and a back cover glass sheet. The LCD cell may comprise a first surface and a second surface. The front cover glass sheet may comprise a first surface and a second surface. The first surface and second surface of the front cover glass sheet may define a front cover glass sheet thickness. The second surface of the front cover glass sheet may be directly bonded to the first surface of the LCD cell. The front cover glass sheet may comprise strengthened glass. The back cover glass sheet may comprise a first surface and a second surface. The first surface and second surface of the back cover glass sheet may define a back cover glass sheet thickness. The first surface of the back cover glass sheet may be directly bonded to the second surface of the LCD cell. The back cover glass sheet may comprise strengthened glass. The LCD assembly may be transparent to light projected onto the second surface of the back cover glass sheet to enable display of an image.

In another embodiment, An LCD assembly for displaying an image may be produced. The method for producing the LCD assembly may comprise supplying an LCD cell, supplying a front cover glass sheet, supplying a back cover glass sheet, directly bonding the front cover glass sheet to the LCD cell, and directly bonding the back cover glass sheet to the LCD cell. The LCD cell may comprise a first surface and a second surface. The front cover glass sheet may comprise a first surface and a second surface. The first surface and second surface of the front cover glass sheet may define a front cover glass sheet thickness. The front cover glass sheet may comprise strengthened glass. The back cover glass sheet may comprise a first surface and a second surface. The first surface and second surface of the back cover glass sheet may define a back cover glass sheet thickness. The front cover glass sheet may comprise strengthened glass. The second surface of the front cover glass sheet may be directly bonded to the first surface of the LCD cell. The first surface of the back cover glass sheet may be directly bonded to the second surface of the LCD cell.

Additional features and advantages of the embodiments described herein will be set forth in the detailed description which follows, and in part will be readily apparent to those skilled in the art from that description or recognized by practicing the embodiments described herein, including the detailed description which follows, the claims, as well as the appended drawings.

It is to be understood that both the foregoing general description and the following detailed description describe various embodiments and are intended to provide an overview or framework for understanding the nature and character of the claimed subject matter. The accompanying drawings are included to provide a further understanding of the various embodiments, and are incorporated into and constitute a part of this specification. The drawings illustrate the various embodiments described herein, and together with the description serve to explain the principles and operations of the claimed subject matter.

### BRIEF DESCRIPTION OF THE DRAWINGS

FIG. 1 schematically depicts an exploded cross sectional view of an LCD assembly according to one embodiment shown and described herein;

FIG. 2 schematically depicts the LCD assembly of FIG. 1 as assembled; and

FIG. 3 shows the test results of first principle stress versus time as a ball is dropped onto sample an LCD assembly comprising a back cover glass sheet and an LCD assembly not comprising a back cover glass sheet.

### DETAILED DESCRIPTION

Reference will now be made in detail to various embodiments of LCD assemblies, examples of which are illustrated in the accompanying drawings. Whenever possible, the same reference numerals will be used throughout the drawings to refer to the same or like parts. An LCD assembly, as described herein, may generally comprise an LCD cell, a front cover glass sheet, and a back cover glass sheet. The mechanical strength of the LCD assembly is improved by the use of a front cover glass sheet in combination with a back cover glass sheet, where the front cover glass sheet and back cover glass sheet are positioned on opposite sides of the LCD cell. In some embodiments of the LCD assembly disclosed herein, the front cover glass sheet and the back cover glass sheet have similar or identical coefficients of thermal expansion (CTE's). Embodiments of the LCD assembly and method for making LCD assembly will be described in more detail herein with specific reference to the appended drawings.

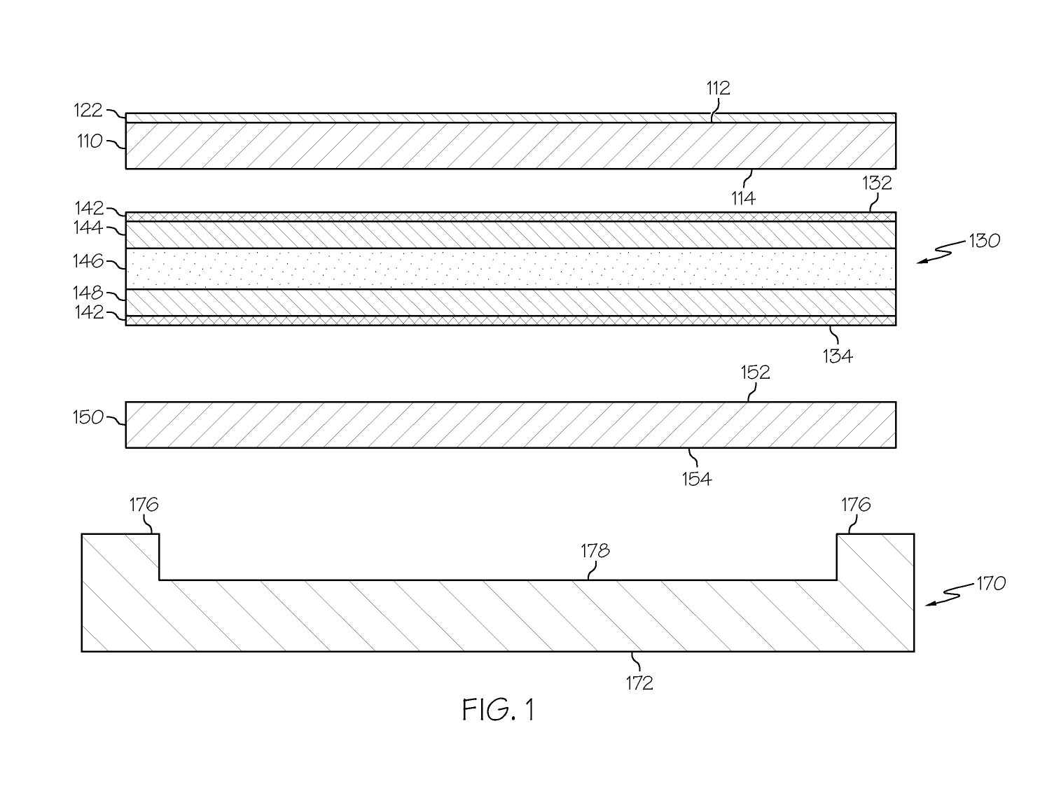

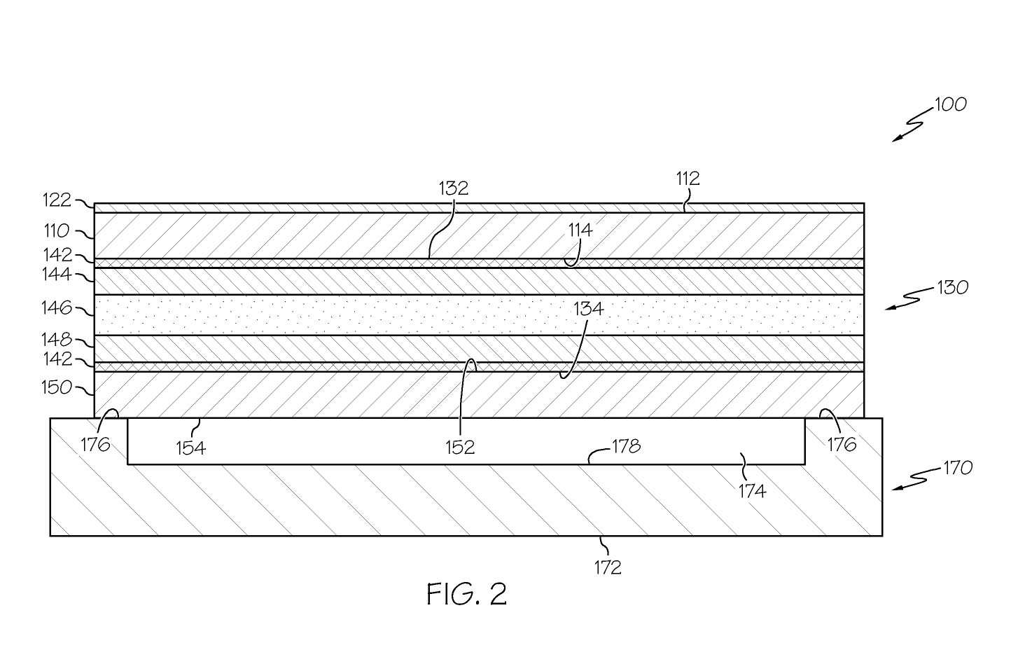

Referring now to FIGS. 1 and 2, exploded (FIG. 1) and assembly (FIG. 2) views of one embodiment of an LCD assembly 100 are schematically depicted. In the embodiments of the LCD assemblies 100 described herein, the LCD assemblies 100 include an LCD cell 130, a front cover glass sheet 110, and a back cover glass sheet 150, where the front cover glass sheet 110 and back cover glass sheet 150 are bonded to the LCD cell 130.

The front cover glass sheet 110 is formed from a strengthened glass. In some embodiments, the strengthened glass may be ion-exchange strengthened glass, such as an alkali-alumino silicate glass. Examples of suitable strengthened glass include, without limitation, ion-exchange strengthened Gorilla™ Glass and Gorilla™ Glass 2 manufactured by Corning, Inc. However, it should be understood that other strengthened glasses may be used for the front cover glass sheet 110. The front cover glass sheet 110 has a top surface 112 and an underside surface 114, each of which include a layer of compressive stress which is imparted to the front cover glass sheet 110 by a strengthening process. The compressive stress extends from both the top surface 112 and the underside surface 114 of the front cover glass sheet 110 into the thickness of the front cover glass sheet 110. The compressive stress improves the mechanical strength of the front cover glass sheet 110 and generally mitigates failure of the front cover glass sheet 110 due to incidental damage (i.e., chips, scratches, or the like). In the embodiments described herein, the compressive stress in the front cover glass sheet 110 may be about 500 MPa or greater and have a depth of layer (DOL) which is greater than or equal to about 30 μm. For example, in some embodiments, the compressive stress may be greater than or equal to 800 MPa or even greater than or equal to 950 MPa. In some embodiments, the DOL may be greater than or equal to about 40 μm or even greater than or equal to about 50 μm. The compressive stress and DOL are determined based on the stress birefringence of the glass as specified in ASTM Standard C1422.

In the embodiments described herein, the front cover glass sheet 110 generally has a thickness T₁ which is less than or equal to about 2 mm. In one embodiment, the front cover glass sheet 110 may have a thickness T₁ which is in a range from about 0.2 mm to about 2 mm. In another embodiment, the front cover glass sheet 110 may have a thickness T₁ which is in a range from about 0.3 mm to about 1 mm. In one exemplary embodiment, the front cover glass sheet 110 has a thickness T₁ of about 0.4 mm.

The LCD assembly 100 may optionally comprise an anti-reflective layer 122 positioned in contact with the top surface 112 of the front cover glass sheet 110. The anti-reflective layer 122 may comprise multiple layers of optical coating or a laminated anti-reflective film. FIG. 1 shows the anti-reflective layer 122 disposed on the front cover glass sheet 110 in an unassembled view. However, in some embodiments, the anti-reflective layer 122 may be added to the front cover glass sheet 110 following the assembly of the front cover glass sheet 110 to the LCD cell 130.

The LCD cell 130 may be any commercially available LCD cell suitable for use in an LCD TV, LCD monitor, or other similar display. The LCD cell 130 comprises a top surface 132 and an underside surface 134 to which the front cover glass sheet 110 and back cover glass sheet 150 are attached, respectively. The LCD cell 130 may generally comprise a liquid crystal material layer 146, a color filter layer 144, a thin film transistor (TFT) layer 148, and at least one polarizer layer 142. The liquid crystal material layer 146 may comprise any liquid crystal substance suitable for use as a liquid crystal in an LCD cell. The TFT layer 148 may comprise a glass sheet, such as for example a glass sheet that acts as a substrate in the TFT layer 148 and onto which a multitude of thin film transistors are deposited. The color filter layer 144 may comprise a glass sheet that has color filtering properties, such as to allow for a color to be viewed on an image projected from the LCD assembly 100 when installed into an electronic device such as a television. In one embodiment, the LCD cell 130 comprises two polarizer layers 142. The polarizer layers 142 may be any layer suitable for use as a light polarizing material such as to allow for the operation of the LCD cell 130. In one embodiment, a polarizer layer 142 may comprise a polarizer film.

The LCD cell 130 of the LCD assembly 100 described herein may have various constructs based on the ordering and placement of the various components and layers of the LCD cell 130. For example, in one embodiment, the TFT layer 148 is attached to the liquid crystal material layer 146 near the underside surface 134 of the LCD cell 130 and the color filter layer 144 is attached to the liquid crystal material layer 146 near the top surface 132 of the LCD cell 130. In such an arrangement, the color filter layer 144 is positioned closer to the top surface 112 of the front cover glass sheet 110 than the TFT layer 148. Polarizer layers 140 may be positioned in contact with the outer surfaces of the TFT layer 148, the color filter layer 144, or both. However, it should be understood that the polarizer layers 140 may be disposed in other positions in the LCD cell 130.

The back cover glass sheet 150 is formed from a strengthened glass. In some embodiments, the strengthened glass may be ion-exchange strengthened glass, such as an alkali-alumino silicate glass. Examples of suitable strengthened glass include, without limitation, ion-exchange strengthened Gorilla™ Glass and Gorilla™ Glass 2 manufactured by Corning, Inc. However, it should be understood that other strengthened glasses may be used for the back cover glass sheet 150. The back cover glass sheet 150 has a top surface 152 and an underside surface 154, each of which include a layer of compressive stress which is imparted to the back cover glass sheet 150 by a strengthening process. The compressive stress extends from both the top surface 152 and the underside surface 154 of the back cover glass sheet 150 into the thickness of the back cover glass sheet 150. The compressive stress improves the mechanical strength of the back cover glass sheet 150 and generally mitigates failure of the back cover glass sheet 150 due to incidental damage (i.e., chips, scratches, or the like). In the embodiments described herein, the compressive stress in the back cover glass sheet 150 may be about 500 MPa or greater and have a depth of layer (DOL) which is greater than or equal to about 30 μm. For example, in some embodiments, the compressive stress may be greater than or equal to 800 MPa or even greater than or equal to 950 MPa. In some embodiments, the DOL may be greater than or equal to about 40 μm or even greater than or equal to about 50 μm. The compressive stress and DOL are determined based on the stress birefringence of the glass as specified in ASTM Standard C1422.

In the embodiments described herein, the back cover glass sheet 150 generally has a thickness T₂ which is less than or equal to about 2 mm. In one embodiment, the back cover glass sheet 150 may have a thickness T₂ which is in a range from about 0.2 mm to about 2 mm. In another embodiment, the back cover glass sheet 150 may have a thickness T₂ which is in a range from about 0.3 mm to about 1 mm. In one exemplary embodiment, the back cover glass sheet 150 has a thickness T₂ of about 0.4 mm. In some embodiments, T₁ and T₂ are substantially the same. In other embodiments, T₁ and T₂ may be within about 50%, within about 25%, or even within about 10% of one another, where T₁ may be greater than T₂ or T₁ may be less than T₂.

Furthermore, the front cover glass sheet 110 has a coefficient of thermal expansion CTE₁ and the back cover glass sheet 150 has a coefficient of thermal expansion CTE₂. In embodiments where the front cover glass sheet 110, the back cover glass sheet 150, or both, are alkali-alumino silicate glass, CTE₁ and/or CTE₂ may be in the range from about 75×10⁻⁷/° C. to about 100×10⁻⁷/° C. In one embodiment, CTE₁ and/or CTE₂ may be in the range from about 80×10⁻⁷/° C. to about 85×10⁻⁷/° C. For example, when the front cover glass sheet 110 and/or the back cover glass sheet 150 is formed from Gorilla™ Glass, CTE₁ and/or CTE₂ is on the order of about 84.5×10⁻⁷/° C. from 0° C. to about 300° C. Alternatively, when the front cover glass sheet 110 and/or the back cover glass sheet 150 is formed from Gorilla™ Glass 2, CTE₁ and/or CTE₂ is on the order of about 80×10⁻⁷/° C. from 0° C. to about 300° C.

The existence of identical or similar CTE's for the front cover glass sheet 110 and back cover glass sheet 150 may balance the forces on the LCD cell 130 that are produced by the front cover glass sheet 110 and back cover glass sheet 150 and may increase the strength of the LCD assembly 100. Specifically, when the back cover glass sheet 150 and the front cover glass sheet 110 have similar coefficients of thermal expansion, the differential expansion between the back cover glass sheet 150 and the front cover glass sheet 110 is minimized, balancing the forces on the LCD cell 130 from the back cover glass sheet 150 and the front cover glass sheet 110 at various temperatures. Accordingly, in some embodiments described herein, the back cover glass sheet 150 generally comprises a strengthened glass which has a coefficient of thermal expansion CTE₂ which is similar to the coefficient of thermal expansion CTE₁ of the front cover glass sheet 110.

In some embodiments, CTE₁ may be within +/−15.0×10⁻⁷/° C. of CTE₂ or even within +/−10.0×10⁻⁷/° C. of CTE₂. For example, in one embodiment CTE₂ of the back cover glass sheet 150 is the same as CTE₁ of the front cover glass sheet 110 (i.e., CTE₂=CTE₁). In some embodiments, CTE₁ may be within +/−25% of CTE₂ or even within +/−10% of CTE₂.

In some embodiments, the front cover glass sheet 110 and the back cover glass sheet 150 are formed from glasses which have substantially the same composition in order to minimize the difference between the coefficients of thermal expansion of the front cover glass sheet 110 and the back cover glass sheet 150. The phrase “substantially the same composition,” as used herein, refers to the composition of the back cover glass sheet 150 and the composition of the front cover glass sheet 110 prior to a strengthening process, such as an ion-exchange strengthening process. Further, it should also be understood that, in other embodiments, the front cover glass sheet 110 and the back cover glass sheet 150 need not be formed from glass with the same or substantially the same composition to achieve the desired similarity with respect the CTE's.

The LCD assembly 100 may further comprise a light source 170 that is capable of projecting light onto the underside surface 154 of the back cover glass sheet 150 and through the LCD cell 130 and top surface 112 of the front cover glass sheet 110 to display an image. In one embodiment, the light source 170 is an LED backlight. In one embodiment, the light source 170 may generally comprise a backside surface 172, a plurality of attachment points 176, and a recessed area 178. The attachment points 176 may project out of the body of the light source 170 and define the recessed area 178, such that when a relatively flat back cover glass sheet 150 is in contact with the attachment points 176, an air gap 174 is formed between the back cover glass sheet 150 and the light source 170.

Referring now to the assembled view of FIG. 2, the underside surface 114 of the front cover glass sheet 110 may be directly bonded to the top surface 132 of the LCD cell 130 and the top surface 152 of the back cover glass sheet 150 may be directly bonded to the underside surface 134 of the LCD cell 130. As used herein, “directly bonded” refers to physical attachment of two or more bodies where the two or more bodies are in direct contact with one another or where there is a bonding material disposed between at least portions of the two bodies. Such a bonding material may enhance the strength of attachment between the two bodies. In one embodiment, the front cover glass sheet 110, the back cover glass sheet 150, or both, may be directly bonded to the LCD cell 130 with a bonding material, such as an adhesive. The adhesive may be an optically clear adhesive. Optically clear adhesives may be made with an acrylic base or silicone base in the liquid form and may be UV cured, thermally cured, or air cured. In another embodiment, the front cover glass sheet 110, the back cover glass sheet 150, or both, may be directly bonded to the LCD cell 130 by lamination. A lamination process may utilize dry film lamination or a liquid optically clear adhesive.

In an assembled state, the LCD assembly 100 may comprise a light source 170 that is positioned in contact with the underside surface 154 of the back cover glass sheet 150 at attachment points 176. The recessed area 178 of the light source 170 may create an air gap 174 that is disposed between the light source 170 and the back cover glass sheet 150. The air gap 174 may have a length measured in the same direction as T₁ and T₂ of between about 0.5 mm and about 4 mm. The air gap 174 may allow for some flexure of the front cover glass sheet 110, LCD cell 130, and back cover glass sheet 150.

Also described herein is a method for producing an LCD assembly 100 for displaying an image. The method may generally comprise supplying the LCD cell 130, the front cover glass sheet 110, and the back cover glass sheet 150, and directly bonding the underside surface 114 of the front cover glass sheet 110 to the top surface 132 of the LCD cell 130 and the top surface 152 of the back cover glass sheet 150 to the underside surface 134 of the LCD cell 130. The method may further comprise supplying the light source 170 capable of projecting light onto the underside surface 154 of the back cover glass sheet 150 and through the LCD cell 130 and the top surface 112 of the front cover glass sheet 110 to display an image, and attaching the light source 17 to the back cover glass sheet 150 such as to allow for an air gap 174 to be disposed between the light source 170 and the back cover glass sheet 150.

The LCD assemblies 100 described herein may have improved mechanical strength. For example, in one embodiment the LCD assemblies 100 described herein may have a stacked strength of greater than about 75 kgf, greater than about 95 kgf, or even greater than about 110 kgf when measured by a load to failure ring-on-ring test. An LCD assembly that does not comprise a back cover glass sheet 150 with a similar front cover glass sheet may only have a stacked strength of about 65 kgf

The LCD assemblies 100 described herein may have reduced mechanical stress when exposed to a ball drop test. For example, in one embodiment, the LCD assembly 100 comprising a back cover glass sheet 150 had at least about 15% less maximum first principle stress, about 20% less maximum first principle stress, or even about 23% less maximum first principle stress, than an LCD assembly not comprising a back cover glass sheet. Details of the experiments used to attain this data can be found in Example 1, below.

### Example 1

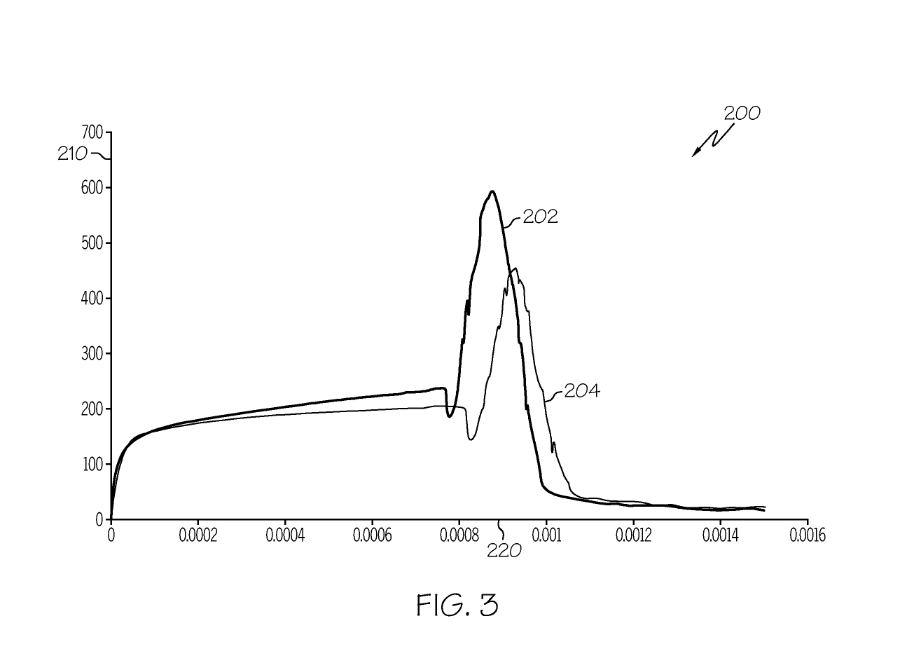

Mechanical stress data was generated for an LCD assembly as described herein (comprising a back cover glass sheet) and an LCD assembly that did not comprise a back cover glass sheet. FIG. 3 shows a plot 200 of the first principle stress (measured in MPa) versus time (measured in seconds) as a ball is dropped onto sample LCD assemblies. First principle stress is recorded on the vertical axis 210 as a function of time on the horizontal axis 220. Data line 202 shows the data set corresponding to an LCD assembly which does not comprise a back cover glass sheet 150. The LCD without a back cover glass sheet used in this example (corresponding to data line 202) comprised a 0.55 mm thick front cover glass sheet, a 1.2 mm thick LCD cell, and an LED backlight with a 2 mm air gap disposed between the LED backlight and the LCD cell. Data line 204 shows the data set corresponding to an LCD assembly as described herein which comprises a back cover glass sheet 150. The LCD assembly with a back cover glass sheet 150 used in this example (corresponding to data line 204) comprised a 0.55 mm thick front cover glass sheet, a 1.2 mm thick LCD cell, a 0.55 mm thick back cover glass sheet 150, and an LED backlight with a 2 mm air gap disposed between the LED backlight and the back cover glass sheet 150. In all of the LCD assembly samples of this example, the cover glass sheets were about 1238 mm×720.2 mm×0.55 mm and the force of the ball that was dropped was 2 joules. The ball was dropped perpendicular to the height and length of the front cover glass sheet and parallel to the thickness of the front cover glass sheet. Time=0 corresponds to the point where the ball first made contact with the sample LCD assembly. When the ball drop test was performed, the LCD assembly comprising a back cover glass sheet (corresponding to data line 204) had a maximum first principle stress of about 450 MPa, while the LCD assembly not comprising a back cover glass sheet (corresponding to data line 202) had a maximum first principle stress of about 590 MPa. Thus, the LCD assembly comprising a back cover glass sheet (corresponding to data line 204) had about 23.7% less maximum first principle stress than the LCD assembly not comprising a back cover glass sheet (corresponding to data line 202).

It should now be understood that the LCD assemblies described herein have improved mechanical strength and damage tolerance. The improved mechanical properties are achieved by using a front cover glass sheet 110 and a back cover glass sheet 150 that may have similar coefficients of thermal expansion. Moreover, due to the improved mechanical properties of the LCD assemblies, the LCD assemblies are well suited for use in various electronic devices and particularly well suited for use in televisions or other electronic displays. In a first aspect, the LCD assembly may comprise: an LCD cell comprising a first surface and a second surface; a front cover glass sheet comprising a first surface and a second surface, the first surface and second surface of the front cover glass sheet defining a front cover glass sheet thickness, wherein the second surface of the front cover glass sheet may be directly bonded to the first surface of the LCD cell, and wherein the front cover glass sheet may comprise strengthened glass; a back cover glass sheet comprising a first surface and a second surface, the first surface and second surface of the back cover glass sheet defining a back cover glass sheet thickness, wherein the first surface of the back cover glass sheet may be directly bonded to the second surface of the LCD cell, and wherein the back cover glass sheet may comprise strengthened glass; and wherein the LCD assembly may be transparent to light projected onto the second surface of the back cover glass sheet to enable display of an image.

In a second aspect, the LCD cell of the first aspect may further comprise a liquid crystal material, a color filter layer, and a thin film transistor layer, wherein the color filter layer may be positioned closer to the first surface of the LCD cell than the thin film transistor layer.

In a third aspect, the LCD assembly of the first aspect has a coefficient of thermal expansion of the front cover glass sheet that may be within +/−15.0×10⁻⁷/° C. of a coefficient of thermal expansion of the back cover glass sheet.

In a fourth aspect, the LCD assembly of the first aspect has a coefficient of thermal expansion of the front cover glass sheet may be within +/−25% of a coefficient of thermal expansion of the back cover glass sheet.

In a fifth aspect, the front cover glass sheet and the back cover glass sheet of the first aspect have substantially the same composition.

In a sixth aspect, the LCD assembly of the first aspect has at least about 23% less maximum first principle stress than an LCD assembly not comprising a back cover glass sheet.

In a seventh aspect, the front cover glass sheet of the first aspect has a thickness from about 0.2 mm to about 2 mm and the back cover glass sheet of the first aspect has a thickness from about 0.2 mm to about 2 mm.

In an eighth aspect, the LCD assembly of the first aspect may further comprise a light source capable of projecting light onto the second surface of the back cover glass sheet and through the LCD cell and the first surface of the front cover glass sheet to display the image.

In a ninth aspect, the LCD assembly of the eighth aspect may comprise an air gap disposed between the light source and the back cover glass sheet.

In a tenth aspect, the light source of the eighth aspect may comprise an LED backlight.

In an eleventh aspect, the front cover glass sheet of the first aspect, the back cover glass sheet of the first aspect, or both, may be directly bonded to the LCD cell of the first aspect with a bonding material.

In a twelfth aspect, the bonding material of the eleventh aspect may be an optically clear adhesive.

In a thirteenth fifteenth aspect, the front cover glass sheet of the first aspect, the back cover glass sheet of the first aspect, or both, are directly bonded to the LCD cell of the first aspect by lamination.

In a fourteenth sixteenth aspect, the LCD cell of the first aspect may further comprise two polarizer layers.

In a fifteenth aspect, the LCD assembly of the first aspect may further comprise an anti-reflective layer positioned in contact with the front cover glass sheet.

In n sixteenth aspect, an LCD assembly for displaying an image may be produced by a method. The method may comprise: supplying an LCD cell comprising a first surface and a second surface; supplying a front cover glass sheet comprising a first surface and a second surface, the first surface and second surface of the front cover glass sheet defining a front cover glass sheet thickness, wherein the front cover glass sheet may comprise strengthened glass; supplying a back cover glass sheet comprising a first surface and a second surface, the first surface and second surface of the back cover glass sheet defining a back cover glass sheet thickness, wherein the front cover glass sheet may comprise strengthened glass; directly bonding the second surface of the front cover glass sheet to the first surface of the LCD cell; and directly bonding the first surface of the back cover glass sheet to the second surface of the LCD cell.

In a seventeenth aspect, the method of the sixteenth aspect may further comprise: supplying a light source capable of projecting light onto the second surface of the back cover glass sheet and through the LCD cell and the first surface of the front cover glass sheet to display the image; and attaching the light source to the back cover glass sheet such as to allow for an air gap to be disposed between the light source and the back cover glass sheet.

In an eighteenth aspect, a coefficient of thermal expansion of the front cover glass sheet of the sixteenth aspect may be within +/−15.0×10⁻⁷/° C. of a coefficient of thermal expansion of the back cover glass sheet of the sixteenth aspect.

In a nineteenth aspect, the front cover glass sheet of the sixteenth aspect has a thickness of between about 0.2 mm to about 2 mm and the back cover glass sheet of the sixteenth aspect has a thickness of between about 0.2 mm to about 2 mm.

In a twentieth aspect, the front cover glass sheet of the sixteenth aspect, the back cover glass sheet of the sixteenth aspect, or both, are directly bonded to the LCD cell of the sixteenth aspect with a bonding material.

It will be apparent to those skilled in the art that various modifications and variations can be made to the embodiments described herein without departing from the spirit and scope of the claimed subject matter. Thus it is intended that the specification cover the modifications and variations of the various embodiments described herein provided such modification and variations come within the scope of the appended claims and their equivalents.

We claim:

1. An LCD assembly, the LCD assembly comprising:
an LCD cell comprising a first surface and a second surface;
a front cover glass sheet comprising a first surface and a second surface, the first surface and second surface of the front cover glass sheet defining a front cover glass sheet thickness, wherein the second surface of the front cover glass sheet is directly bonded to the first surface of the LCD cell, and wherein the front cover glass sheet comprises strengthened glass;
a back cover glass sheet comprising a first surface and a second surface, the first surface and second surface of the back cover glass sheet defining a back cover glass sheet thickness, wherein the first surface of the back cover glass sheet is directly bonded to the second surface of the LCD cell, and wherein the back cover glass sheet comprises strengthened glass; and
wherein the LCD assembly is transparent to light projected onto the second surface of the back cover glass sheet to enable display of an image.

2. The LCD assembly of claim 1, wherein the LCD cell further comprises a liquid crystal material, a color filter layer, and a thin film transistor layer, wherein the color filter layer is positioned closer to the first surface of the LCD cell than the thin film transistor layer.

3. The LCD assembly of claim 1, wherein a coefficient of thermal expansion of the front cover glass sheet is within +/−15.0×10⁻⁷/° C. of a coefficient of thermal expansion of the back cover glass sheet.

4. The LCD assembly of claim 1, wherein a coefficient of thermal expansion of the front cover glass sheet is within +/−25% of a coefficient of thermal expansion of the back cover glass sheet.

5. The LCD assembly of claim 1, wherein the front cover glass sheet and the back cover glass sheet have substantially the same composition.

6. The LCD assembly of claim 1, wherein the LCD assembly has at least about 23% less maximum first principle stress than an LCD assembly not comprising a back cover glass sheet.

7. The LCD assembly of claim 1, wherein the front cover glass sheet has a thickness from about 0.2 mm to about 2 mm and the back cover glass sheet has a thickness from about 0.2 mm to about 2 mm.

8. The LCD assembly of claim 1, wherein the LCD assembly further comprises a light source capable of projecting light onto the second surface of the back cover glass sheet and through the LCD cell and the first surface of the front cover glass sheet to display the image.

9. The LCD assembly of claim 8, wherein the LCD assembly comprises an air gap disposed between the light source and the back cover glass sheet.

10. The LCD assembly of claim 8, wherein the light source comprises an LED backlight.

11. The LCD assembly of claim 1, wherein the front cover glass sheet, the back cover glass sheet, or both, is directly bonded to the LCD cell with a bonding material.

12. The LCD assembly of claim 11, wherein the bonding material is an optically clear adhesive.

13. The LCD assembly of claim 1, wherein the front cover glass sheet, the back cover glass sheet, or both, are directly bonded to the LCD cell by lamination.

14. The LCD assembly of claim 1, wherein the LCD cell further comprises two polarizer layers.

15. The LCD assembly of claim 1, wherein the LCD assembly further comprises an anti-reflective layer positioned in contact with the front cover glass sheet.

16. A method for producing an LCD assembly for displaying an image, the method comprising:
supplying an LCD cell comprising a first surface and a second surface;
supplying a front cover glass sheet comprising a first surface and a second surface, the first surface and second surface of the front cover glass sheet defining a front cover glass sheet thickness, wherein the front cover glass sheet comprises strengthened glass;
supplying a back cover glass sheet comprising a first surface and a second surface, the first surface and second surface of the back cover glass sheet defining a back cover glass sheet thickness, wherein the front cover glass sheet comprises strengthened glass;
directly bonding the second surface of the front cover glass sheet to the first surface of the LCD cell; and
directly bonding the first surface of the back cover glass sheet to the second surface of the LCD cell.

17. The method of claim 16, the method further comprising:
supplying a light source capable of projecting light onto the second surface of the back cover glass sheet and through the LCD cell and the first surface of the front cover glass sheet to display the image; and
attaching the light source to the back cover glass sheet such as to allow for an air gap to be disposed between the light source and the back cover glass sheet.

18. The method of claim 16, wherein a coefficient of thermal expansion of the front cover glass sheet is within +/−15.0×10⁻⁷/° C. of a coefficient of thermal expansion of the back cover glass sheet.

19. The method of claim 16, wherein the front cover glass sheet has a thickness of between about 0.2 mm to about 2 mm and the back cover glass sheet has a thickness of between about 0.2 mm to about 2 mm.

20. The method of claim 16, wherein the front cover glass sheet, the back cover glass sheet, or both, are directly bonded to the LCD cell with a bonding material.
